(19) United States
(12) Patent Application Publication
(10) Pub. No.: US 2003/0183989 A1
(43) Pub. Date: Oct. 2, 2003

(54) Process for medeling ceramic tiles

(75) Inventor: Roberto Fabbroni, Faenza (IT)

Correspondence Address: YOUNG & THOMPSON, 745 SOUTH 23RD STREET 2ND FLOOR, ARLINGTON, VA, 22202

(73) Assignee: KESER S. R. L., Faenza (IT)

(21) Appl. No.: 10/368,633

(22) Filed: Feb. 20, 2003

(30) Foreign Application Priority Data
Mar. 26, 2002 (IT) FO2002A000008

(51) Int. Cl. C04B 33/36

(52) U.S. Cl. 264/609; 264/678; 264/680; 264/118; 264/119

(57) ABSTRACT

FIGS. 25 and 26 show in sequence a 270° bending of a tile predisposed on a bottom surface thereof in which surface a straight groove has been made at a position where a bend is to be performed. FIG. 5 is a detailed illustration showing the groove after having been filled following bending. In the illustrated example, the bend of the tile is obtained, after making the groove in the opposite surface to the upper surface, by subjecting the tile to overall or localized heating as it is resting on a support made of refractory material which support has two surfaces which are reciprocally perpendicular and inclined with respect to a vertical, at a suitable angle for the tile to be stable thanks to a part thereof resting on the surface, and a projecting part of the tile to be able, when softened, to fall by gravity until it reaches and rests perfectly on the other surface 10″ of the support.

### BACKGROUND OF THE INVENTION

The ceramics industry has reached such a high technological level that practically any decoration can be made to perfection, and practically all natural stones very accurately imitated.

The above is true, however, only of flat tiles, as it is almost impossible to find (among surface-covering materials) special pieces that are not planar, i.e. L-shaped, U-shaped and curved, having all the same identical patterns, finishing and color tones as the tiles they will be laid with in the covering of stairs, skirting boards, hand-rails, corners and other architectural details.

The prior art contains attempts at satisfying the above need, but all offerings are obviously improvised or insufficient; a common practice for corners is to cut tiles into two parts and re-join them in a corner using grout.

The main aim of the present invention is to provide a low-cost series production of special one-piece non-planar articles (L-shaped, U-shaped, curved and so on) which are identical in terms of composition, finishing and color tone to ceramic tiles coming from normal production lines, thus permitting a perfect match when laid.

The inventive concept of the invention is very simple and novel and indeed revolutionary, and consists in fashioning the shaped pieces from the very same tiles produced normally, and thus already surface-treated.

Thanks to the presence of materials in both the blank and the surface decoration which are plastically deformable at high temperatures, the process of the invention consists in heating the whole tile, or possibly only the part thereof to be remodeled, up to a point at which a necessary softness is achieved so that the softened tile can be subjected to a refashioning into a desired and predetermined shape, in which shape it is maintained during the following gradual cooling process which will bring the tile back into a hardened state. For simpler shapes a localized heating can be carried out only in the zone of the tile which needs to be softened, possibly using a torch or blow-pipe. Thus the tile can be bent and kept in bent position until sufficiently cooled. The bending can be performed using mechanical systems of a relatively simple type as it is not difficult to grip the opposite ends of the tile without damaging them, as they remain cold.

An alternative to this operation is provided by the invention, in which the tiles are subjected to heating-up in a kiln, causing them to soften just enough for the shape thereof to be modeled on an underlying refractory support. No alteration results on the surface finishing of the tile.

The refractory support can be of fixed shape or can be variable in order to follow the shaping of the tile as it softens. The tiles can rest on the supports by force of gravity or can be fixed there using compression organs or bending organs or whatever is most appropriate.

The most significant practical advantage of the process of the invention, however it is carried out in detail, consists in the fact that at any time special pieces can be made, pieces which are perfectly combinable with any batch of tiles. This is because the reshaped tiles are in fact taken from the batch involved.

The modeling of the shaped tiles could, however, be performed during firing of the whole batch in the kiln. The tiles to be specially shaped could be rested on shaped supports, either by gravity or using other methods, and during the softening period of both the ceramic materials and the surface materials they would then bend and model to the desired form.

### SUMMARY OF THE INVENTION

To facilitate the bending and curving of the pieces and to obtain minimum surface variations, i.e. stretching or compressing, as well as to reduce the kiln time and overall working times, straight grooves are made in the backs of the tiles to be modeled. These are the parts of the tiles which will soften during the heating process, resulting in the two adjacent parts, previously coplanar, assuming the conformation of the underlying supports. The grooves, made by milling when the tiles come from the stock houses, might instead be fashioned during pressing, or by incision at some point after pressing.

In any case, once the hot-bending or modeling has been concluded, the grooves are filled with suitable resins, preferably bi-component polyurethane resins which will go a long way to restoring the mechanical resistance of the original piece.

### BRIEF DESCRIPTION OF THE DRAWINGS

These and other characteristics of the process of the invention will be non-specifically described herein below with reference to eleven plates of drawings containing 43 figures, in which:

FIGS. 1 and 2 relate to a normal tile, here represented before and after bending, to produce and angle of about 270° or in any case an angle of more than 180°;

FIGS. 3, 4 and 5 relate to a first example of bending, destined to form an angle of about 270° (or in any case an angle of more than 180°) on the upper face of the tile, where a groove has been made on the back of the tile, to be filled after bending;

FIGS. 6, 7 and 8 relate to a second example of bending destined to form an angle of about 270° (or in any case an angle of more than 180°) on the upper face of the tile, where a groove has been made on the back of the tile, to be filled after bending;

FIGS. 9, 10 and 11 relate to a third example of bending destined to form an angle of about 270° (or in any case an angle of more than 180°)on the upper face of the tile, where a groove has been made on the back of the tile, to be filled after bending;

FIGS. 12, 13 and 14 relate to an example of bending destined to form an angle of about 90° (or in any case an angle of less than 90°) on the upper face of the tile, where a groove has been made on the back of the tile, to be filled after bending;

FIGS. 15 and 16 show in sequence a 270° bend being performed on a normal tile;

FIGS. 17, 18, 19 and 20 show in sequence a U-bend being performed on a normal tile;

FIGS. 21, 22, 23 and 24 show, in sequence, a curve being performed on a normal tile;

FIGS. 25 and 26 show, in sequence, a 270° bend being performed on a tile having a groove made in a back surface thereof at the position where the bend is to be made;

FIGS. 27, 28, 29 and 30 show, in sequence, a U-bend being performed on a tile resting on its back side with a straight groove made at each of two positions where bends are to be induced;

FIGS. 31, 32, 33 and 34 show, in sequence, a bending operation being performed on a tile arranged resting on a back side thereof, with a plurality of straight grooves made at the positions at which bends are to be induced; FIGS. 35, 36 and 37 show, in sequence, a 90° bending induced on a tile lying on its back and having a straight groove made at the position at which bends are to be induced;

FIGS. 38, 39, 40, 41, 42 and 43 show, in sequence, a 270° bend induced on a normal tile resting on an adjustable refractory support, on which the bending is produced gradually.

### DESCRIPTION OF THE PREFERRED EMBODIMENTS

As mentioned above, the main aim of the process is to provide special non-planar pieces which have the same color tones and identical finishing to the flat tiles with which they will subsequently be laid.

The top surface, i.e. the surface which will be in view once the tile (denoted by a letter of the alphabet in the figures) is laid is indicated throughout by the number 1, while 2 denotes the grooves made in the bottom surfaces of the tiles, and 3 denotes the resin which is used to fill the grooves once the bending operation has been carried out. In all of the examples included in the figures and the following description, the heating necessary for bending and modeling the tiles can involve the whole tile or a part thereof according to whether the tiles are introduced into the kiln or heated using torches or other equivalent means only in the interested zones.

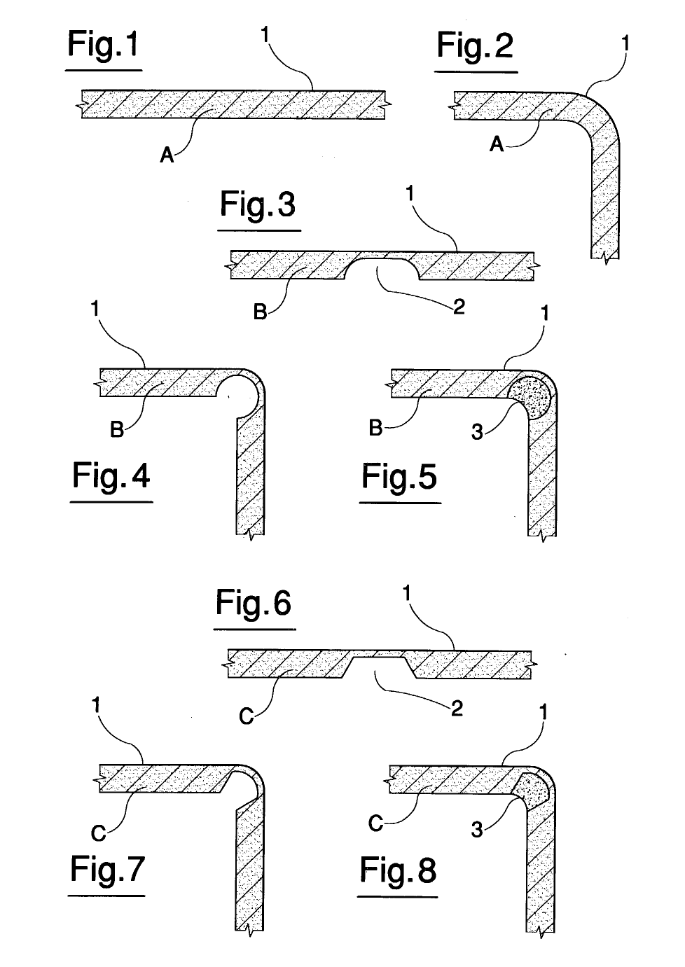

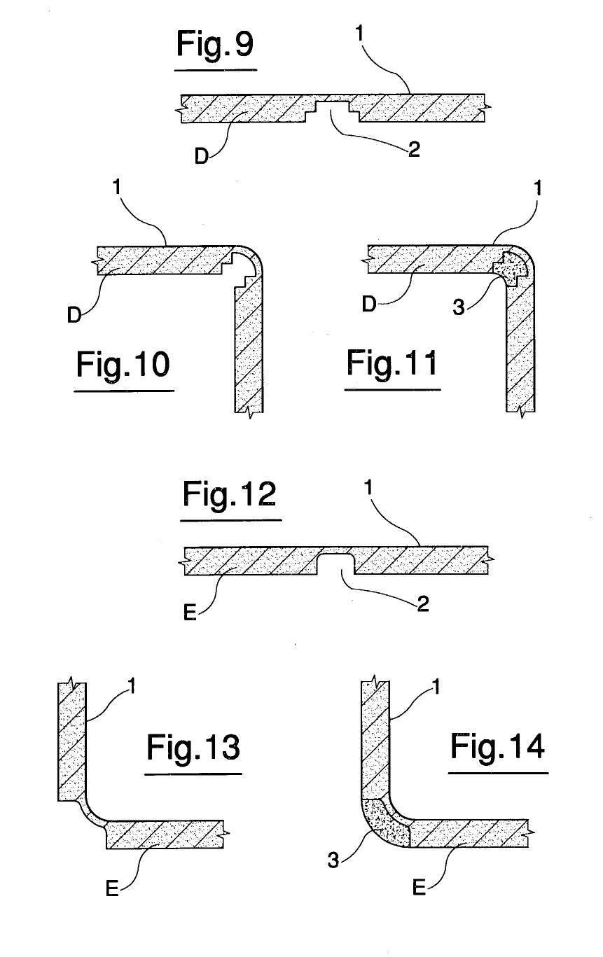

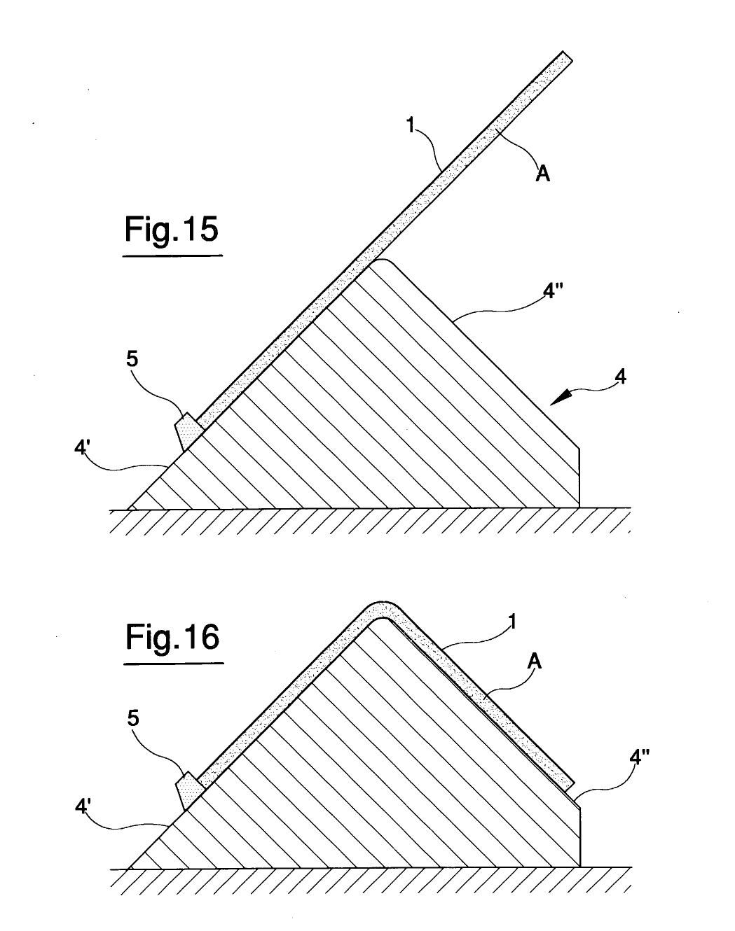

According to the first example of the figures (plate 3) a 270° bend, such as the one shown in FIGS. 1 and 2, can be obtained with either total overall heating or localized heating of the tile A resting with the bottom surface thereof on a support 4 made of refractory material having two surfaces 4′ and 4″ perpendicular one to another, preferably connected by an arc and inclined with respect to the vertical at the most suitable angle in order for the amount of the tile on the surface 4′ (FIG. 15) to be enough to guarantee tile A stability on the support while (when the tile has been softened) bending is carried out by force of gravity. At the end of the bending operation, the tile should rest perfectly on the other surface 4″ of the support (FIG. 16).

A rule 5, made of refractory material, is positioned along the face 4′ of the support 4 so that the distance of the bend from the tile edge can be perfectly regulated, as well as providing a guarantee that the tile is squared properly on the support 4 so that the bend is parallel to the edge.

The above is all that is necessary for obtaining a plurality of specially-fashioned pieces, all identical to one another as long as, as happens in any firing process, the tile is allowed to cool on the support as long as necessary for its shape to stabilize.

In the example shown in plate 4, the two 270° bends (for obtaining a U-shaped tile as in FIG. 20) are obtained by overall or localized heating of the tile as it rests with its bottom surface on a refractory support 7 having a rectangular shape and preferably joined at its topmost edge.

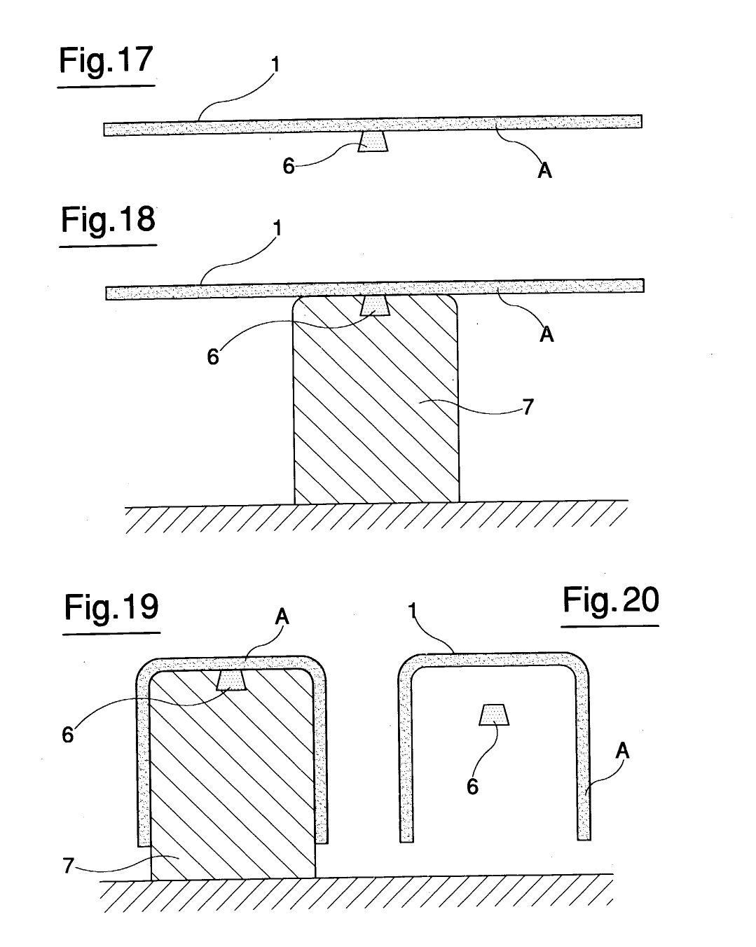

A bar 6, made of refractory material and preferably trapezoid in section, is cemented below the tile A, i.e. at the bottom surface of the tile (FIG. 17), and is inserted in a corresponding seating afforded in the top surface of the support 7 (FIG. 18). It temporarily fixes the tile to hold it firm while the two bends are achieved.

Once the two wings of the tile A have bent down until they rest against the vertical walls of the support 7 (FIG. 19), and the tile has cooled on the support 7, the bar 6 can be removed, if necessary (FIG. 20).

In the example shown in plate 5, the curving of a normal tile A, necessary to obtain the conformation of FIG. 24, is obtained by overall or localized heating of the tile A resting on the bottom surface thereof of a refractory support 9, which support 9 is shaped according to the final tile configuration required.

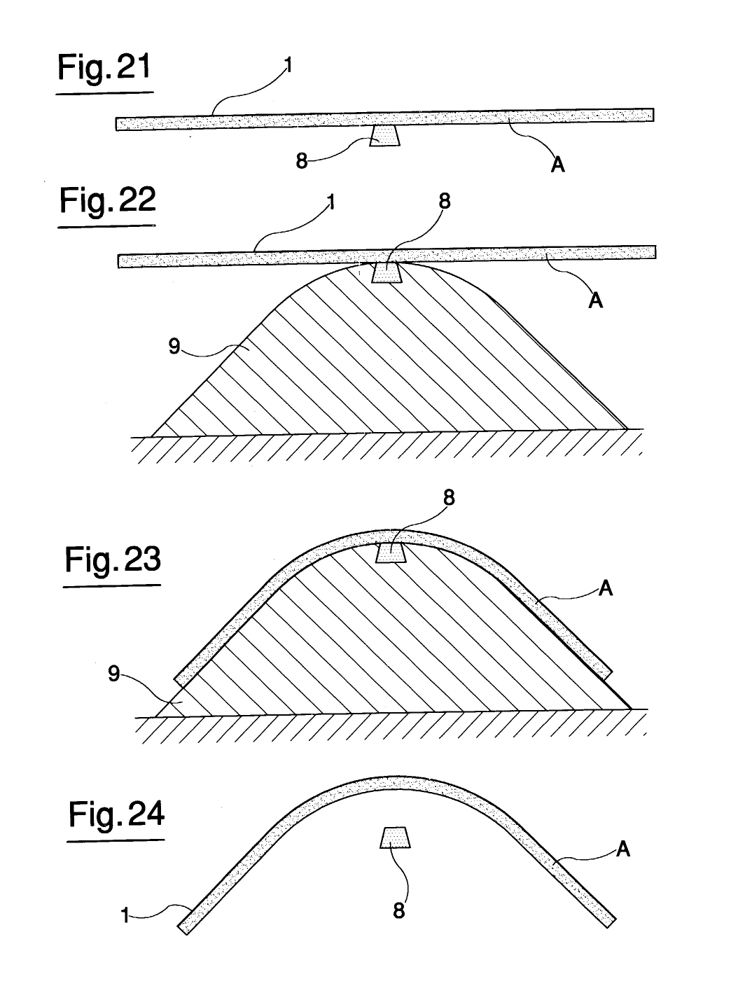

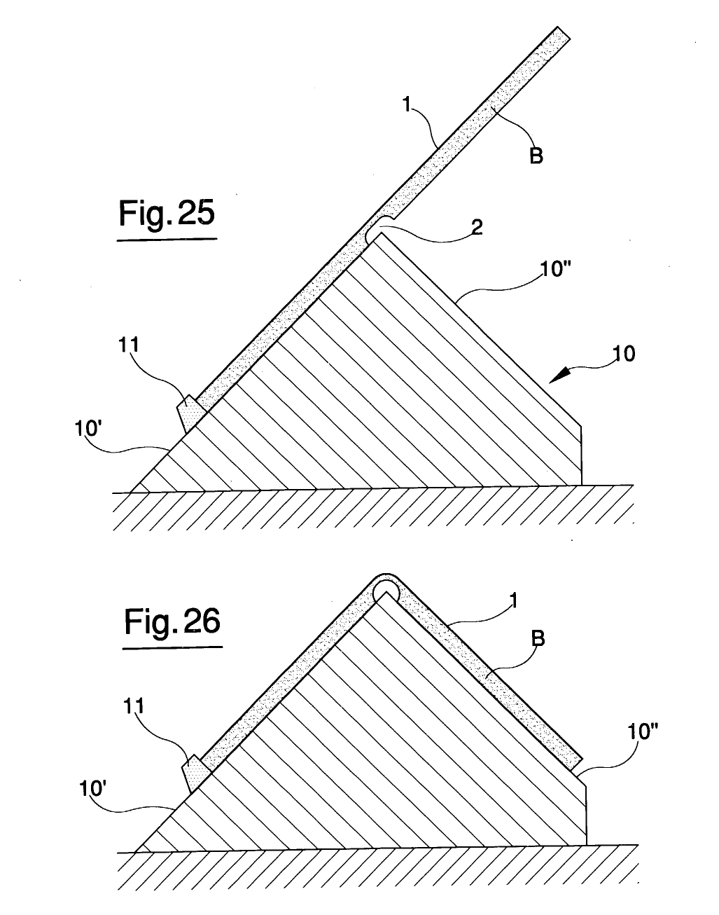

A bar 8, made of refractory material, preferable trapezoid in section, is cemented below i.e. at the bottom surface of the tile (FIG. 21), and is inserted in a corresponding seating afforded in the top surface of the support 9 (FIG. 22). It temporarily fixes the tile to hold it firm while the two bends are achieved.

Once the two wings of the tile A have bent down until they rest against the curved walls of the support (FIG. 23), and the tile has cooled on the support 9, the bar 8 can be removed, if necessary.

In the example shown in plate 6, a 270° bend, as shown in FIGS. 3, 4 and 5 of plate 1, can be obtained by overall or localized heating of the tile B arranged, after forming the groove 2 in the bottom surface of the tile, on a refractory support 10 having two surfaces 10′, 10″ reciprocally perpendicular and inclined, with respect to the vertical, at the most suitable angle in order for the tile on the support to be stable and for the projected part of the tile to descend by force of gravity when softened and come to rest perfectly against the other surface 10″ of the support (FIG. 26).

A rule 11, made of refractory material, is positioned along the face 11′ of the support 10 so that the groove 2 in the tile is perfectly positioned at the position at which the bending will take place, i.e. the meeting of the first surface 10″ with the second surface 10″.

After the bending and cooling on the refractory support, the groove is filled with resins suitable for restoring the mechanical resistance of the original piece (see FIG. 3).

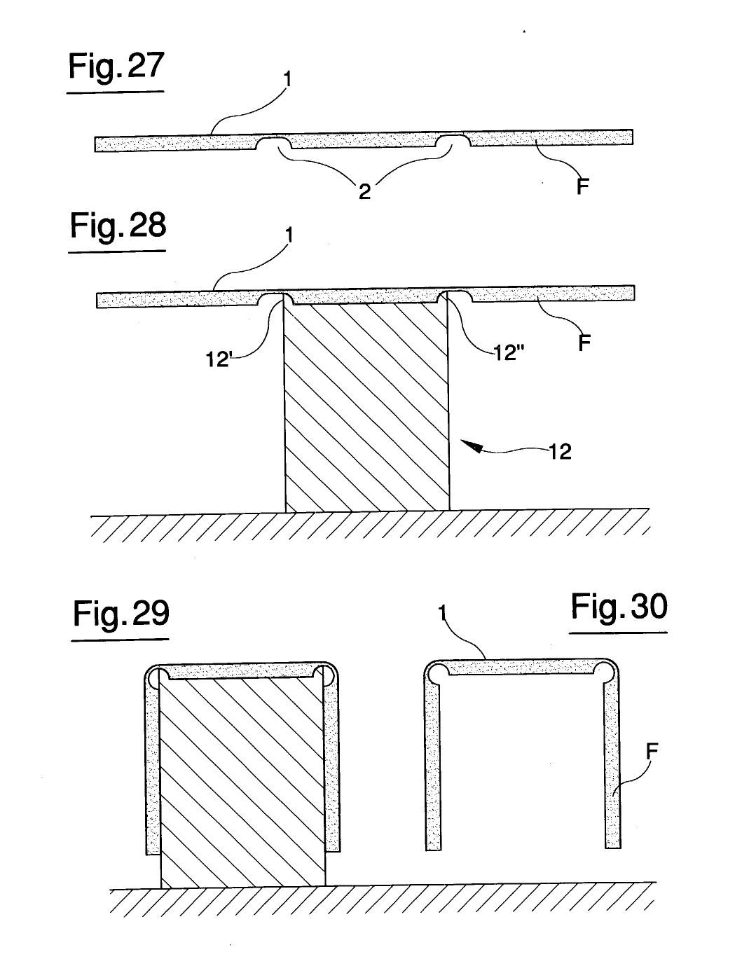

In the example in plate 7, the double bending at right angles of a tile F (FIG. 27), to make a U-shape as in FIG. 30, is achieved by overall or localized heating of the tile after making two grooves 2 similar to what is illustrated in FIGS. 3, 4 and 5, resting the bottom surface of the tile on a refractory support 12 having a rectangular section and with two projections 12′ and 12″ emerging from the upper surface of the support, which projections 12′ and 12″ enter the grooves 2 in the tile. The tile is thus constrained during the bending process, i.e. when the two wings of the tile come to rest against the vertical walls of the refractory support 12.

After the U-shaping is complete and the tile F has cooled on the refractory support, the two grooves are filled, as in FIG. 3, using suitable resins for restoring the mechanical resistance of the original tile.

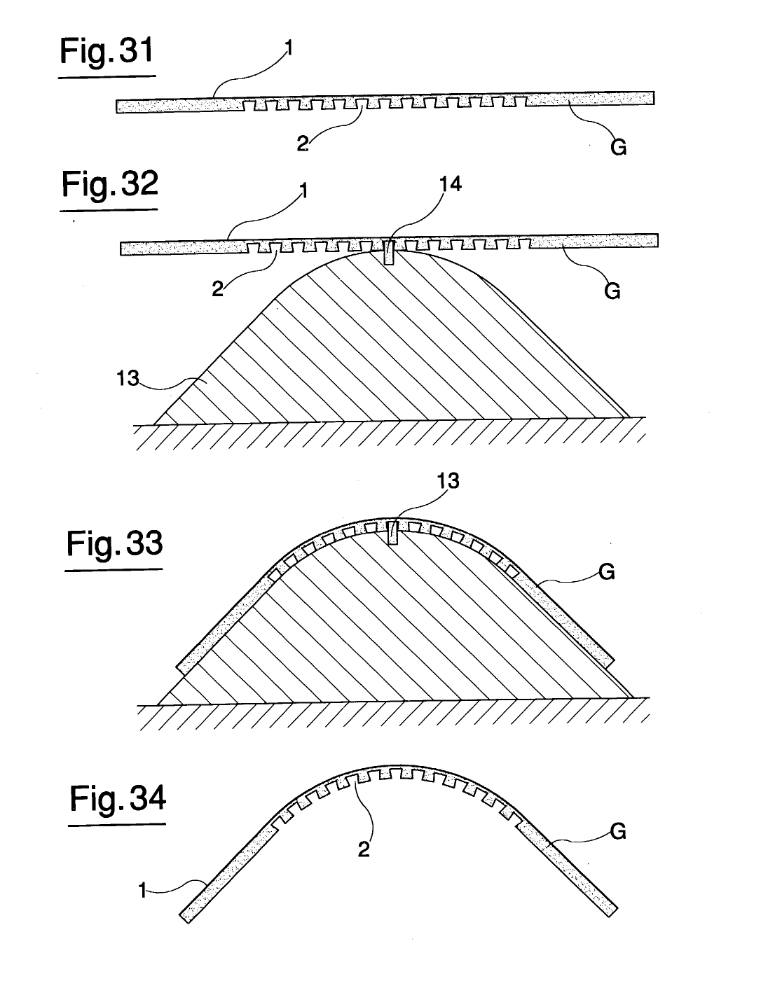

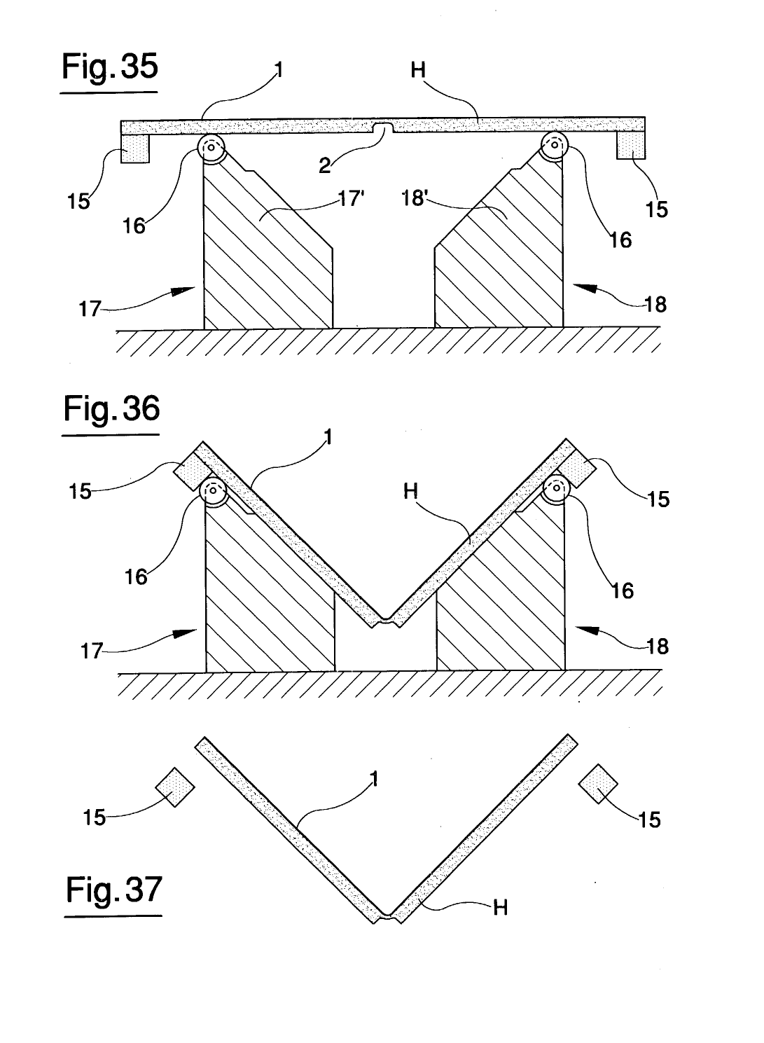

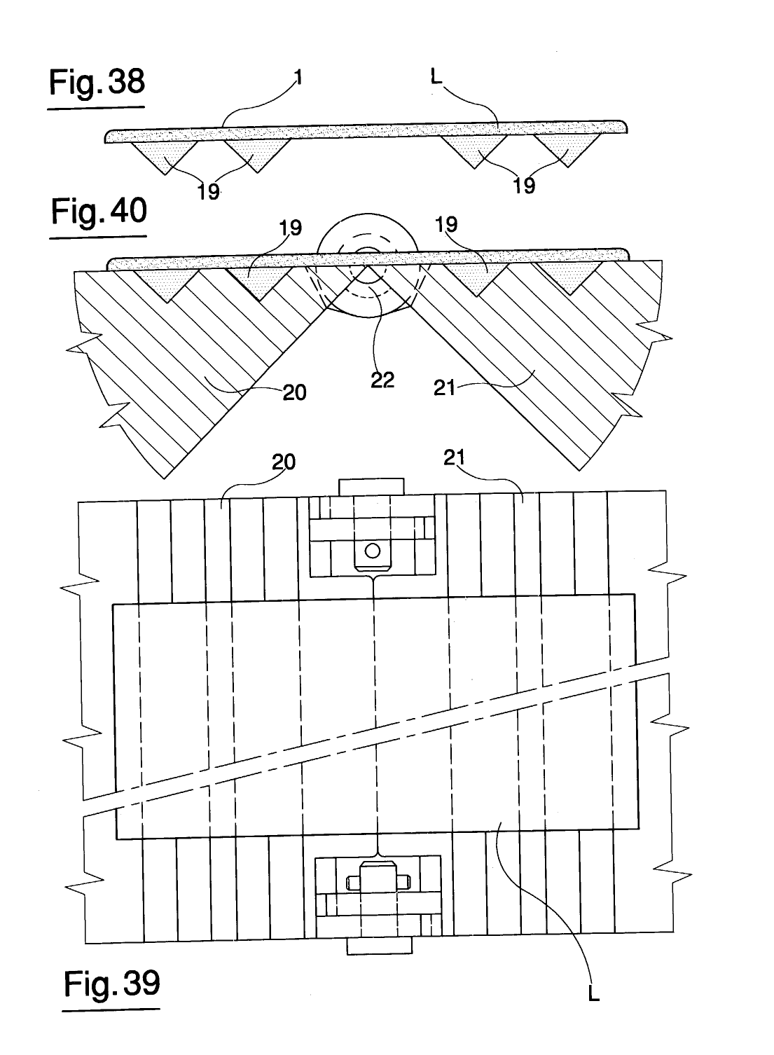

In the example of plate 8, the bending of a tile G (FIG. 31) to achieve the conformation of FIG. 34 can be obtained by overall or localized heating of the tile, with the bottom surface of the tile, after making a plurality of straight grooves 2 at the zone of the tile to be curved, resting on a refractory support 13 shaped according to the shape to be obtained.

A bar 14, also made of refractory material, projects from the top of the support 13 and is inserted into one of the grooves 2 of the tile G (if the tile curvature is to be symmetrical, it will be inserted in the central groove). The tile will therefore be temporarily constrained so that it will stay immobile during the tile softening and bending process.

After bending and cooling on the support 13, the grooves can be filled using suitable resins which will restore the mechanical resistance of the original tile. In the example shown in plate 9, a bending like the one shown in FIGS. 12, 13 and 14 of plate 2 can be achieved, i.e. the forming on the tile top surface of an angle of about 90° or less after overall or localized heating of the tile. The bottom surface of the tile H is arranged on the supports, after making the straight groove and fixing two refractory bars 15 parallel to the groove at either end of the tile H. Two horizontal-axis rollers 16 project from the top of two twin refractory supports 17 and 18, the upper surfaces 17′ and 18′ of which are inclined convergingly in a downwards direction according to the angle of bend to be obtained in the tile H.

The perfect execution of the bending is assured not only by resting the two wings of the tile on the surfaces 17′ and 18′ on the twin refractory supports, but also thanks to the presence of the bars 15 which operate in contact with the rollers to limit the extent of the descent of the tile H down the supports. Once more the tile H must be left to cool on the supports before removing the bars 16 (FIG. 37) and filling the groove as in FIG. 14.

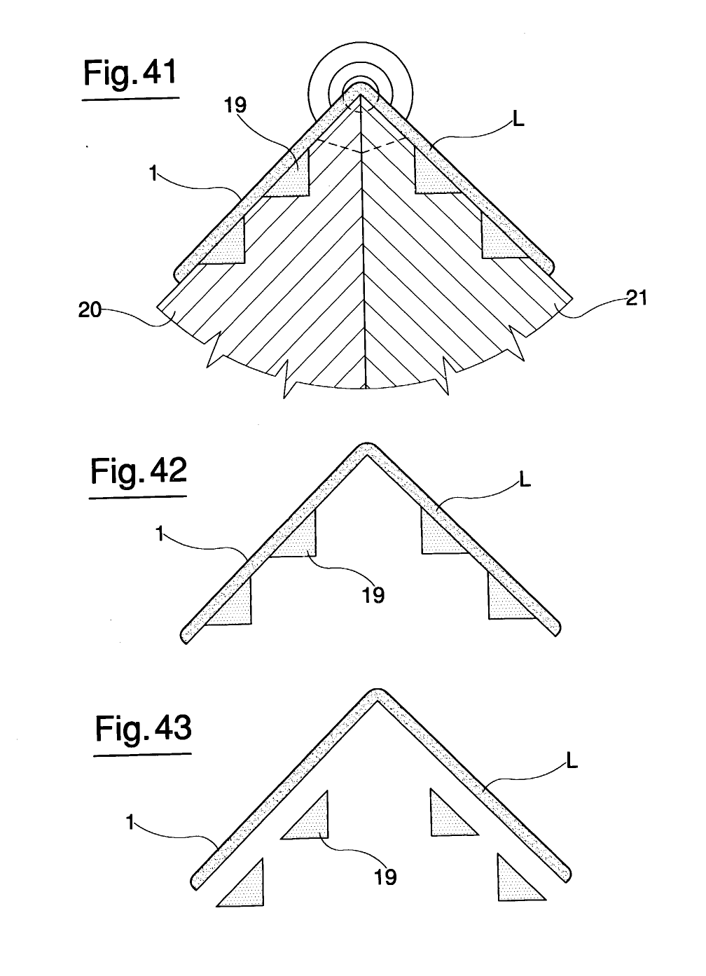

In the example of plates 10 and 11, the bending of a normal tile L to form an angle of about 270° in the top surface of the tile can be achieved, with overall or localized heating of the tile, on a support made of refractory material which, in order to make the bending process gradual, is adjustable. The support is made of two parts, 20 and 21, conformed so that they can be hinged together by means of a pivot pair 22 which enable angular variations of 90° to be made. The two parts 20 and 21 of the support, coplanar when the tile L is first rested thereon (FIGS. 39 and 40), are perpendicular (FIG. 41) at completion of the bending operation.

To ensure that the tile L stays in position on the support, and to avoid damaging the rounded edges of the tile L, at least one bar 19 of refractory material is fixed to the bottom surface of each half of the tile L, which bars 19 are lodged in special housings in the two halves of the support.

As in this example the tile is normal and without grooves in the bottom surface of the tile for aiding the forming of a right angle, the degree of tile softening required is so high that more than one bar 19 for each half of the tile is advisable, in order to prevent the tile from deforming in unwanted directions. The section of the bars 19 is a right-angled isosceles triangle, and the surface of the bar passing through the hypotenuse is the same surface that is then fixed to the tile; thus, after the bending of the support 20-21 with the tile L thereon (FIG. 41), the other two surfaces of each bar 19, i.e. the surfaces passing through the catheti, are arranged so that one is horizontal and the other vertical, i.e. in a position in which the tile can be removed by simple lifting.

The above arrangement is necessary since the pivots 22 and the pivot housings on the support 20-21 would not allow removal of the tile-bar assembly with a motion which was parallel to the hinge axis on the support and the bend line of the tile L.

After cooling on the support, the bent tile can be removed from the support and detached from the refractory bars 19.

What is claimed:

1). A process for modeling ceramic tiles, suitable for realizing non-planar single pieces having a same aesthetic appearance as normal flat tiles, to be laid together with the flat tiles, comprising the following stages:
heating of at least a portion of a tile to a temperature at which the at least a portion softens;
deformation by bending of the at least a portion of the tile until a predetermined shaping thereof is achieved;
cooling of the at least a portion of the tile.

2). The process of claim 1, wherein for simplest target conformations of the tiles, heating of the at least a portion of the tile is performed using blow-torches or the like, which enable softening to be limited to the at least a portion of the tile and bending to be achieved using any suitable system for bending and keeping the tile in a predetermined position up until cooling is complete and the at least a part of the tile has solidified.

3). The process of claim 1, wherein the tiles to be modeled, whether already fired or still to be fired, are inserted into a kiln, the tiles being placed on specially shaped supports, preferably made of refractory material, on which supports the tiles will achieve a desired shape as during softening due to overall application of heat the tiles will come to rest at least by effect of gravity on the specially-shaped supports.

4). The process of claim 1, wherein straight grooves are made in a bottom surface of the tiles and at a position corresponding to a position at which bends in the tiles are to be made, rendering easier and more precise the bending of the tiles, and reducing a time necessary for achieving an adequate overall or localized temperature of the tiles in order for the bending to occur, and also reducing a time necessary for the tiles to cool subsequent to firing.

5). The process of claim 4, wherein the grooves are made by milling in already-fired tiles, and in not-fired tiles the grooves are impressed during a pressing of a ceramic mix; or at made by incision after pressing.

6). The process of claim 4, wherein the grooves, made on a bottom surface of the tiles, are, after a hot tile-bending process, filled with resins which restore a mechanical resistance of the tile which mechanical resistance is similar to a mechanical resistance of an unbent tile.

7). The process of claim 1, wherein bending a tile (plate 3) is achieved by overall or localized heating of the tile resting on a support 4 made of refractory material having two surfaces which are reciprocally perpendicular and inclined, with respect to a vertical, at a suitable angle for the tile to rest on a surface of the two surfaces, a rule being applied to keep the tile A stable during bending of the tile so that a projecting part of the tile can descend when softened by force of gravity and come to rest perfectly against another surface of the two surfaces.

8). The process of claim 1, wherein a double bending of the tile (plate 4), for obtaining a final U-conformation, is obtained by overall or localized heating of the tile resting on a support made of refractory material from which support two opposite end portions of the tile project, which end portions during softening descend to form two wings of a U-conformed tile.

9). The process of claim 8, wherein a bar made of refractory material and preferably having a trapezoid section is cemented to a bottom surface of the tile, opposite a top surface of the tile which will be in view, and is inserted in a corresponding seating afforded in an upper surface of the support in order to constrain the tile temporarily and ensure that two bends therein are perfectly executed according to a predetermined position and direction.

10). The process of claim 1, wherein in order to bend a tile (plate 5) the tile is rested on a support made of refractory material and heated overall or locally, and upon softening will descend until it is resting on the support; a bar being temporarily cemented on a bottom surface of the tile and being housed in a housing afforded on the support in order to ensure a correct positioning of the tile on the support during the entire bending process.

11). The process of claim 4, wherein the bending of the tile (plate 6) is achieved by overall or localized heating of the tile resting, after having a groove made therein, on a support made of refractory material having two surfaces which are reciprocally perpendicular and inclined, with respect to a vertical, at an angle considered suitable for stability of the tile B to be bent and a projecting part thereof to be bent, by softening, until by force of gravity it comes to rest perfectly on another of the surfaces of the support; a rule made of refractory material being positioned along one of the two surfaces of the support so that a groove in the tile will automatically be positioned at a position where the tile will be bent, the position being a point where the two faces meet.

12). The process of claim 4, wherein two bends necessary for obtaining a U-conformation (plate 7) in a tile are achieved, after two straight grooves have been made in the tile, by subjecting the tile to overall or localized heating while resting on a support made of refractory material and having a rectangular section with two projections departing from an upper surface of the support; the two projections entering the two grooves in the tile, so that the tile is constrained to the support during bending, when two wings of the tile descend to rest on two vertical walls of the support.

13). The process of claim 4, wherein in order to bend a tile (plate 8) a plurality of straight grooves are made in a bottom surface of the tile and the bottom surface is rested on a top surface of a support made of refractory material; a bar made of refractory material projecting from the top surface of the support and inserting into one of the plurality of grooves in the tile and ensuring a correct tile positioning during softening of the tile due to overall or localized heating thereof.

14). The process of claim 4, wherein bending a tile (plate 9) to form an angle of 90° or less in a top surface of the tile is achieved by subjecting the tile to overall or localized heating after having made a straight groove in the bottom surface thereof and having fixed two bars made of refractory material on two ends of the tile which are projecting from the support and parallel to the groove; the tile being positioned on two horizontal-axis rollers projecting from tops of two refractory twin supports which twin supports have topmost surfaces which are inclined convergingly downwards according to a predetermined angle of bending to be performed on the tile.

15). The process of claim 1, wherein bending a normal planar tile (plates 10 and 11) to form on the top surface thereof an angle of about 270° is achieved by overall or localized heating of the tile resting on a support made of refractory material which, in order to make the bending gradual, is adjustable, being realized in two parts, conformed in such a way that a union of the two parts is achieved by means of a hinge formed by two pivots, allowing 90° variations of inclination of the two parts.

16). The process of claim 15, wherein in order to ensure keeping the tile in position and in order to prevent damage to rounded edges of the tile, at least one bar made of refractory material is fixed beneath each of two halves of the tile, which two at least one bar are housed in corresponding seats in the support; a second of the at least one bar being a right-angled isosceles triangle having a surface passing through a hypotenuse, which is a surface used for fixing the at least one bar to the tile, so that after the support is bent, with the tile resting thereon, two other surfaces of the bar, which pass through the catheti, are arranged one thereof horizontally and one thereof vertically, enabling a removal of the tile simply by lifting out of the support.
